(19) United States
(12) Patent Application Publication
(10) Pub. No.: US 2021/0126461 A1
(43) Pub. Date: Apr. 29, 2021

(54) LIGHTING NETWORK FOR CONTROLLING REACTIVE POWER DEMAND

(71) Applicant: SIGNIFY HOLDING B.V., EINDHOVEN (NL)

(72) Inventors: Vasu POOJARY, EINDHOVEN (NL); Narendranath UDUPA, EINDHOVEN (NL); Mahadev CHOLACHAGUDDA, EINDHOVEN (NL); Venkata Sriram PULLELA, EINDHOVEN (NL); Vikram SHIVANNA, EINDHOVEN (NL)

(21) Appl. No.: 16/617,371

(22) PCT Filed: May 16, 2018
(86) PCT No.: PCT/EP2018/062699

§ 371 Date: Nov. 26, 2019

(30) Foreign Application Priority Data
May 29, 2017 (IN) 201741018755
Aug. 2, 2017 (EP) 17184415.2

(51) Int. Cl. H02J 3/18; H05B 45/355

(52) U.S. Cl. CPC H02J 3/1892; H02J 3/1821; H05B 45/355

(57) ABSTRACT

A lighting network for altering a power factor of an alternating current, AC, supply (5). The lighting network comprises luminaires (2, 3) having reactive components of a first reactive type which are controllably coupled, by a controller, to the AC supply so as to adjust the power factor of the AC supply. The controller controls the coupling of the luminaires based on a power factor signal indicative of a power factor of the AC supply, which is influenced by an appliance (6) with a reactive load of a second reactive type, which appliance is different to any one of the luminaires. Preferably, the first reactive type is capacitive, and the second reactive type is inductive.

### FIELD OF THE INVENTION

This invention relates to the field of lighting networks, and in particular to lighting networks that receive an alternating current, AC, supply.

### BACKGROUND OF THE INVENTION

Electrical power distribution networks face an issue of poor mains power supply quality due to voltage and frequency fluctuations, as well as variations in reactive power and higher harmonic contents in power lines. Balancing at least reactive electrical power between an electrical mains supply and a connected load (i.e. balancing supply and demand) is often used to improve mains power supply quality.

Typically, in order to balance supply and demand of electrical power to a load, generation of electrical power is modified to follow load demand. However, as there may be sudden changes in a load or electrical generation capabilities, such as generator shutdown, relying only on modifying this generation is not always efficient and reliable.

At present, to partially overcome this issue, demand side management (DSM) may be used, in which the end user will reduce/shut down at least some of a load at peak times (Peak Load Management) or at the request of a utility company (Demand Response).

GB2411971A describes a power factor adjustment device which may be applied to a streetlight. The power factor adjustment device detects an input current and voltage of the streetlight so as to meter the power factor of the streetlight. Capacitors of a circuit of the streetlight may be switched between the supply and the load by the power factor adjustment unit so as to assist in balancing the supply and demand of electrical power to the load.

US20150130363A1 discloses a LED driving device with a plurality of capacitors at the input and parallel with the rectifier. The capacitors are selectively switched on based on an input voltage or an output voltage of a converter in the LED driving device.

### SUMMARY OF THE INVENTION

The drawback in the prior art is that it is limited in a single luminaire, such as a single streetlight, and it can only compensate the power factor in that specific luminaire. In a lighting network comprising a plurality of luminaires, it is not economical to deploy a power factor adjustment device in each of the luminaires. Furthermore, in a larger electrical network comprising a lighting network and other appliances, if using devices according to the prior art, the lighting network can only compensate for itself. Such a network is unable to compensate a power factor decrease caused by the other appliances.

U.S. Pat. No. 7,531,922B1 discloses a method and apparatus for using lighting to perform facility-wide power factor correction. The solution is that electronic lighting ballast intentional presents a non-unity power factor load. The ballast is programmed to create either a power factor or a harmonic distortion that purposely counters a different power factor or different harmonic distortion created elsewhere in the building and/or to create a reduced harmonic distortion or a unity power factor. The drawback of this prior art is that it is relatively complex to modify the ballast's behavior since the ballast is typically an active circuit and the control loop of the ballast needs to be tuned to achieve function which is not easy.

A basic idea of the embodiments of the invention is implementing the power factor compensation in a distributed manner, such that one luminaire can compensate for another appliance's power factor deterioration. Both the luminaire and the another appliance are connected to the same AC supply, although they may be at the same or different locations in the hierarchal electrical distribution network. At the main AC input of the hierarchal distribution network, the power factor is compensated, and can reduce the requirement to the utility provider. The luminaire is capable of receiving a command from a remote control, which command is associated with the another appliance's power factor deterioration.

The invention is defined by the claims.

According to examples in accordance with an aspect of the invention, there is provided a lighting network comprising: a plurality of luminaires adapted to connect to an alternating current, AC, supply, wherein each luminaire comprises a light emitting arrangement and a reactive component of a first reactive type selectively couplable to the AC supply; and a controller adapted to: receive a power factor signal, indicative of a power factor of the AC supply, and influenced by an appliance with a reactive load of a second reactive type connected to the AC supply, wherein the appliance is different to any one of the luminaires; and control the coupling of the reactive component of each luminaire to the AC supply based on the received power factor signal of the appliance so as to adjust the power factor of the AC supply.

The lighting network enables luminaires in a lighting network to participate in grid power quality correction. In particular, luminaires are provided with a reactive component (e.g. comprising a capacitor, inductor or supercapacitor), which may be controllably coupled to a AC power supply, such as a mains supply. In some examples, the reactive component may shunt at least some of the AC power supply (e.g. to a ground or reference voltage).

This enables the lighting network to control the power factor and voltage balance of an AC supply. Thus, the lighting network may help compensate a poor quality AC supply by improving the power factor of the AC supply and/or reducing a voltage imbalance. Such a lighting network may, in particular, help grid stabilization when the lighting network is installed in a building participating in active/reactive compensation.

A difference from the prior art U.S. Pat. No. 7,531,922B1 is that it does not program or tune a driver or a ballast in the luminaire, but only needs coupling or decoupling the reactive component which is separate from the lighting driver. The application is quite convenient.

In order to control the power factor of the AC supply, the controller controls the coupling of two or more reactive components of a first reactive type, of a respective two or more luminaires, based on a received power factor signal. Thus, there is provided a system level implementation in which reactive components of luminaires are managed so as to enable control over the power factor of the AC supply.

This allows for more precise control over how/where the power factor of the AC supply is compensated or otherwise adjusted. In this way, compensation of an AC supply may be distributed throughout a lighting network, rather than being concentrated in a single luminaire. This may further enable improved techniques of power factor management to be implemented on a system-wide level, such as location specific management or grouping luminaires to be managed.

The received power factor signal is influenced by an appliance with a reactive load of a second reactive type (i.e. not necessarily associated with luminaires), and changes accordingly. In this way, the controlling of the reactive components of the luminaires may compensate the deviance in power factor caused by the demands of other appliances with a reactive load, such as an HVAC system, on an electrical network. As such, a power factor for an entire electrical network may be corrected or improved by a lighting network of that electrical network.

The power factor signal may be obtained from an energy meter, which may be positioned at a mains input to a building or an intermediate node between the mains input and loads drawing power from the mains input. This ensures that the lighting system assists in compensating for a poor power factor provided to a plurality of different loads (i.e. rather than just a single luminaire).

Preferably, each reactive component of the first reactive type is the same one of a capacitive component and an inductive component, and the reactive load of the second reactive type is the other of a capacitive load and an inductive load. In some other embodiments, the reactive component of each luminaire may, for example, comprise individually controllable capacitive and inductive components to provide improved control over the power factor of the AC supply.

Preferably, the first reactive type is capacitive, and the second reactive type is inductive. Many heavy loads in the electrical network are inductive, such as those with motor/compressor, for example air conditioner, refrigerator, electrical elevator. Thus this embodiment can better mitigate the influence of those heavy loads to the power factor.

The lighting network (with the luminaires) may be adapted to be connectable to a first distribution branch of the AC supply, wherein the appliance with a reactive load of a second reactive type is in the same first distribution branch, and the lighting network further comprises a power factor detector adapted to detect the power factor of the AC supply at an input node of the lighting network, and the controller is adapted to receive the power factor signal from the power factor detector. Here the lighting network may be mixed/interleaved with appliances in the same distribution branch, so that power factor compensation may be done close to an appliance affecting the power factor of the AC supply.

In other embodiments, the lighting network is connectable to a first distribution branch of the AC supply, wherein the appliance with a reactive load of the second reactive type is in a second, different distribution branch of the AC supply, wherein the controller is adapted to receive the power factor signal from a remote power factor detector associated with the appliance with a reactive load of the second reactive type in the second distribution branch. In the electrical distribution network, different kind of devices are sometimes put in different branches for an ease of controlling/monitoring. However, the luminaire in one branch can still be used to compensate another appliance in another branch, and the power factor at the main input, supplied by the utility provider, is still improved.

There may therefore be provided a power factor detector adapted to detect the power factor of the AC supply at a variety of locations of an electrical network. In some embodiments, the power factor detector monitors a mains supply to a particular electrical network (e.g. associated with an entire building). In other embodiments, the power factor detector monitors a supply provided at a node associated with one or more loads drawing power from the mains supply. The power factor detector may comprise an energy meter or an energy sub-meter.

In particular, a power factor detector may detect a power factor in a distribution branch of the plurality of luminaires or in a distribution branch of the appliance with a reactive load of the second reactive type. The detected power factor may therefore either be local to the luminaires/other appliance or more distant from the luminaires/other appliance.

Optionally, the power factor detector detects a power factor at an intermediate node to which a combination of the luminaires and the appliance with a reactive load of a second reactive type is connected. However, the power factor detector may instead detect a power factor at an intermediate node to which only the appliance with a reactive load of the second reactive type is connected.

Optionally, the plurality of luminaires comprises at least two sets of two or more luminaires; and the controller is adapted to: obtain a respective power factor signal associated with an AC supply provided to each set of two or more luminaires; and control the coupling of the reactive component of each luminaire, in the plurality of luminaires, based on the power factor signal associated with the set of that luminaire.

There may be provided groups/sets of two or more luminaires. Each group of luminaires may be associated with a respective node of the AC supply, representing a distribution branch of that AC supply. A node may be represented by an energy meter or sub-meter with a communication port, which monitors a power supply to different appliances associated with respective groups/sets of luminaires. The controller may be adapted to obtain respective power factor signals for these different appliances by reading the meter through communication port.

In this way, adjustment of the power factor of the AC supply may be performed by groups/sets of luminaires separately. In particular, groups/sets of luminaires may be adapted to adjust the power factor separately based on a power factor signal associated with that set. This provides extra flexibility in controlling the luminaries individually or in groups, without having to control all luminaries in the same manner.

In some embodiments, each luminaire in a set of two or more luminaires is connected to a same node, and wherein each set of two or more luminaires is connected to a different node or distribution branch.

In this way, the luminaires are placed in different locations/levels/branches in the electrical distribution network. This allows selection of an appropriate group of luminaires in different locations/levels/branches so as to provide better compensation.

Optionally, at least one set of two or more luminaires is associated with a respective set of one or more appliances with a reactive load of a second reactive type, and the controller is adapted to control the coupling of the reactive component of the at least one set of two or more luminaires according to power factor of the respective appliances with a reactive load of a second reactive type.

Thus, each set of luminaires may be responsible for adjusting the power factor of an AC supply provided to a particular or specific appliance with a reactive load of the second reactive type. This may improve the power factor adjustment/correction, as more precise control over power factor adjustment may be realized by providing dedicated luminaires for particular appliances.

The controller may be adapted to control the coupling of the reactive component of each luminaire further based on a proximity relationship, between the luminaire and an appliance with a reactive load of the second reactive type, in a distribution hierarchy of the AC supply.

The controller may therefore be capable of controlling the reactive components of luminaires based on a positional relationship between the luminaires and the appliance with a reactive load(s) of the second reactive type.

This may allow the reactive components of luminaires proximate or near an appliance with a reactive load (of the second reactive type) to be controlled. It has been identified that providing compensating reactive components (of the first reactive type) close to the appliance with a reactive load (of the second reactive type) improves compensation of the power factor of the AC supply, e.g. when compared to compensating appliance with a reactive load positioned more distant.

The positional relationship may represent a physical proximity, indicating how close the luminaire itself is to an appliance with a reactive load of the second reactive type, or a network proximity, indicating how close connections of the luminaire and the appliance with a reactive load (of the second reactive type) to a power supply are to one another. Thus, the positional relationship may be one or more of the following: length of wire between, distance in meters, number of components between, number of other loads/luminaires between, number of meters/nodes between, hierarchical distance and so on.

An advantage of selecting a nearby luminaire to perform power factor compensation/adjustment is that of reducing the effective length over which current harmonics flow in a wire. For example, if the compensation is performed by a more distant luminaire then current harmonics have to be transmitted up to a more distant node for the luminaire.

There is also proposed the concept of an electrical network comprising a lighting network as previously described; and comprising at least one appliance with a reactive load of the second reactive type connected to the AC supply.

The electrical network may be associated with a building, location or other infrastructure. It will be apparent that a lighting network according to an embodiment may improve a power efficiency of an electrical network by compensating for the changes in reactive power caused by the at least one appliance with a reactive load of the second reactive type in the electrical network.

Each at least one appliance with a reactive load of the second reactive type may comprise one or more inductive loads, wherein each appliance optionally comprises a Heating, Ventilation and Air Conditioning, HVAC, unit; an elevator; a fan; a printer; a scanner; and/or a fax machine. The reactive load of the second reactive type in those appliance normally comprises inductive coils, a compressor, and/or a motor.

In some examples, the lighting network is adapted to be connected to a first distribution branch of the AC supply, wherein the at least one appliance with a reactive load of a second reactive type is also connected to the same first distribution branch, wherein the lighting network further comprises a power factor detector adapted to detect the power factor of the AC supply at an input node of the lighting network, and the controller is adapted to receive the power factor signal from the power factor detector.

In other examples, the lighting network is adapted to be connected to a first distribution branch of the AC supply, wherein the at least one appliance with a reactive load of the second reactive type are in a second, different distribution branch of the AC supply, wherein the electrical network further comprises a remote power factor detector adapted to detect the power factor of the AC supply in the second distribution branch and the controller is adapted to receive the power factor signal from the remote power factor detector.

Optionally, the controller is adapted to select a subset of the plurality of luminaires based on a proximity relationship between the subset and the at least one appliance with a reactive load of the second reactive type in the AC distribution hierarchy.

According to examples in accordance with another aspect of the invention, there is provided a method of controlling a lighting network, having two or more luminaries adapted to connect to an alternating current, AC, supply, wherein each luminaire comprises a light emitting arrangement and a reactive component of a first reactive type selectively couplable to the AC supply, the method comprising: receiving a power factor signal, indicative of a power factor of the AC supply, and influenced by at least an appliance with a reactive load of a second reactive type connected to the AC supply, wherein said appliance is different to any one of the luminaire; and controlling the coupling of the reactive component of each luminaire to the AC supply based on the received power factor signal so as to adjust the power factor of the AC supply.

The method may further comprise detecting the power factor of the AC supply at a node of the lighting network.

The plurality of luminaires may comprise at least two sets of two or more luminaires, and the method optionally comprises: obtaining a respective power factor signal associated with an AC supply provided to each set of two or more luminaires; controlling the coupling of the reactive component of each luminaire, in the plurality of luminaires, based on the power factor signal associated with the set of that luminaire.

Optionally, the method further comprises controlling the coupling of the reactive component of each luminaire further based on a positional relationship between the luminaire and an appliance with a reactive load of the second reactive type.

There may also be provided a computer program product comprising computer program code means adapted to implement the method described above when said program is run on a computer.

These and other aspects of the invention will be apparent from and elucidated with reference to the embodiment(s) described hereinafter.

### BRIEF DESCRIPTION OF THE DRAWINGS

Examples of the invention will now be described in detail with reference to the accompanying drawings, in which:

FIG. 1 shows a lighting network according to a first embodiment in an electrical network;

FIG. 2 illustrates a luminaire for a lighting network according to the first embodiment;

FIG. 3 illustrates a lighting network according to an embodiment in a more complex electrical network;

FIG. 4 illustrates a lighting network according to an embodiment in another electrical network;

FIGS. 5 and 6 illustrate power factor triangles for a lighting load, other loads and a total load of an electrical circuit, before and after power factor compensation; and

FIG. 7 is a flowchart illustrating a method according to an embodiment.

### DETAILED DESCRIPTION OF THE EMBODIMENTS

The invention provides a lighting network for altering a power factor of an alternating current, AC, supply. The lighting network comprises luminaires having reactive components which are controllably coupled, by a controller, to the AC supply so as to adjust the power factor of the AC supply. The controller controls the coupling of the luminaires based on a power factor signal indicative of a power factor of the AC supply, which is influenced by an appliance with a reactive load of a second reactive type, which appliance is different to any one of the luminaires.

According to a concept of the invention, there is proposed a lighting network having a controller and a plurality of luminaires. Each luminaire comprises a reactive component or load selectively couplable to an AC supply, wherein the coupling of the reactive component is controlled by the controller. The controller may thereby adjust a power factor of the AC supply (which may be affected by other appliance with a reactive load) by controlling a coupling of the reactive components of the luminaire to the AC supply.

Embodiments are at least partly based on the realization that luminaires may be provided with reactive components controllable by a central controller. This enables a central controller to control the operation of a plurality of luminaires based on a determined power factor. This allows for improved and more precise control over the power factor of the AC supply.

Illustrative embodiments may, for example, be employed in electrical networks for buildings or other infrastructure, which commonly have appliances with a reactive load (such as HVAC systems) connected to a mains supply.

The terms ‘reactive component’ and ‘reactive load’ refer to any impedance arrangement which alters a phase difference between a current and voltage in a circuit containing such an impedance arrangement. Examples of reactive component/loads include any capacitive or inductive components/load, such as capacitors, inductors, motors, HVAC systems and so on. Typically, as a demand by a reactive load increases, so an induced phase difference between the current and voltage both across the load and in the input AC mains increases.

Enabling control over the power factor of an AC supply of an electrical network may similarly enable control over the voltage balance of the AC supply.

The term ‘power factor’ is commonly understood to be the ratio between the real power (provided to a load by an AC supply) and an apparent power in the circuit powered by the AC supply. That is, the power factor is a characteristic of a relationship between a power provided by an AC supply and a power transferred to a load. For the sake of clarity, the power factor has been linked to the AC supply. The term ‘power factor of an AC supply’ is a ratio between the real power provided by that AC supply to a load and an apparent power used by the load. Thus, the power factor of the AC supply may also be the power factor of a network or sub-network powered by the AC supply. A power factor of less than one indicates that the voltage and current waveforms are not in phase.

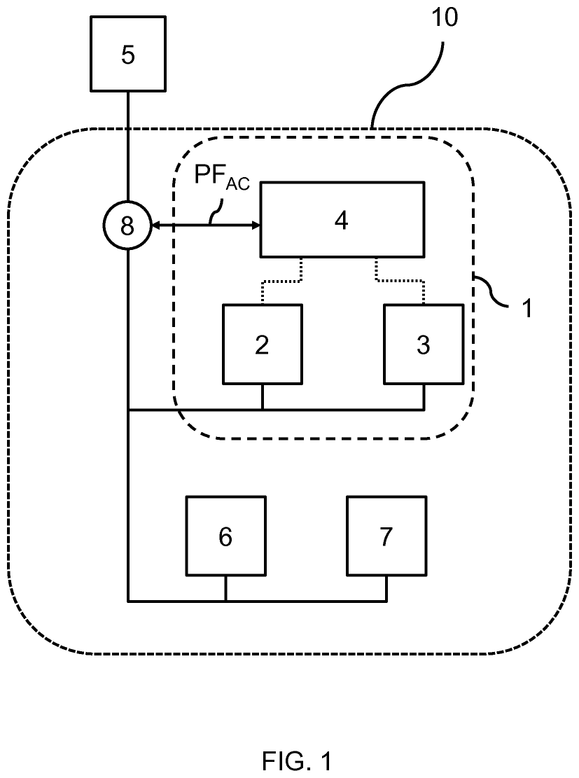

FIG. 1 illustrates a lighting network 1, according to a first embodiment, in the context of a simple electrical network 10 connected to an AC supply 5. The electrical network 10 may represent an electrical network of a building or other infrastructure.

The electrical network 10 comprises the lighting network 1 formed of a plurality of luminaires 2, 3 and a controller 4. The plurality of luminaires comprises a first luminaire 2 and a second luminaire 3. Each luminaire is connected to the alternating current, AC, supply 5 for the electrical network 10. Each luminaire comprises a light emitting arrangement (not shown) and a reactive component/load of a first reactive type (not shown), the reactive load of the first reactive type being selectively or controllably couplable to the AC supply 5.

The electrical network 10 also comprises at least one other appliance 6, 7 with a reactive load of a second reactive type connected to the AC supply 5. In particular, the at least one other appliance with a reactive load of a second reactive type comprises a first appliance 6 with a reactive load and a second appliance 7 with a reactive load.

The reactive load of a second reactive type may be considered to be the combined reactive load of the appliances. Of course, the reactive load of the second reactive type may be attributable to a single or more than one appliance.

The first reactive type and the second reactive type are different. For example, the reactive component of the first reactive type preferably comprises or consists of a capacitive component, and the appliance with a reactive load of the second reactive type preferably comprises or consists of an inductive load. The appliances with a reactive load of a second reactive type may, for example, comprise inductive loads such as coils, compressors, or motors; for example, appliances may comprise Heating, Ventilation and Air Conditioning (HVAC) systems; elevators; fans; printers; scanners; fax machines and so on.

Each at least one other appliance may comprise one or more individual reactive loads (e.g. capacitors or inductors), which together form an overall reactive load of the second reactive type. Preferably, the overall reactive load of the at least one appliance is an inductive load (i.e. the combination of all the capacitors/inductors of an appliance results in an overall inductive load).

The controller 4 of the lighting network 1 is adapted to receive a power factor signal PF_{AC} indicative of a power factor of the AC supply. The power factor signal may, for example, be generated by a meter 8 of the AC supply. The power factor signal is responsive to/influenced by the one or more appliances 6, 7 with a reactive load of the second reactive type. It will be clear that as demands by appliances with a reactive load change (e.g. they are switched on/off) so a power factor of the AC supply changes accordingly.

The controller 4 is adapted to control the coupling of the reactive components of the first reactive type (not shown) of the luminaires 2, 3 based on the power factor signal.

By controlling the reactive components of a first reactive type, a power factor of the AC supply may be controlled centrally by a single controller 4. By basing the control of the reactive loads on a power factor signal PF_{AC}, a deviance in the power factor signal caused by the one or more appliances with a reactive load of the second reactive type 6, 7 may be corrected, compensated or otherwise altered.

The controller 4 may adjust the magnitude of power factor adjustment caused by the luminaires by adjusting the number of luminaires participating in power factor adjustment. For example, if only the first luminaire 2 is controlled to participate in power factor adjustment, the power factor will be adjusted to a lesser extent than if both the first 2 and second 3 luminaires are controlled to participate in power factor adjustment.

The controller 4 thereby provides a system level implementation of controlling reactive loads/components of luminaires so as to enable control over the power factor of the AC supply. In particular, a power factor of the AC supply may be adjusted according to a measured power factor of the electrical system. This allows for correction, compensation and/or improvements to the power factor of the AC supply to be made. This is markedly different from the compensation at device/appliance level of the prior art GB2411971A.

There may be any number of luminaires in the lighting system, for example, at least 100 or at least 1000. This may represent all the luminaires required for a building/location. The greater the number of luminaires, the more a power factor of the AC supply can be adjusted in terms of magnitude and/or precision.

For example, 1000 luminaires each having a reactive load or component of 1 μF enable a greater adjustment to a magnitude of the power factor than 100 luminaires having a reactive load of 1 μF. However, 1000 luminaires each having a reactive load of 0.1 μF enable a more precise adjustment to a power factor when compared to 100 luminaires each having a reactive load of 1 μF (but with a same magnitude adjustment to the power factor).

The controller may, in some embodiments, be a central energy manager of an electrical network. For the purposes of this description, the term ‘meter’ and ‘power factor detector’ is considered interchangeable.

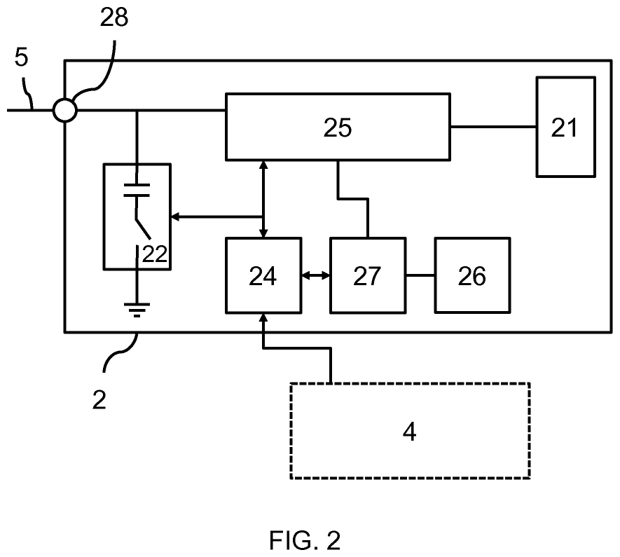

FIG. 2 illustrates an embodiment of a luminaire 2 of the lighting network 1 according to the first embodiment.

The luminaire 2 comprises a light emitting arrangement 21 and a reactive component 22 of a first reactive type, selectively couplable to the AC supply 5.

The lighting arrangement 21 may comprise one or more LEDs or other light emitting elements, such as halogen bulbs. Preferably, the lighting arrangement 21 comprises an LED string of two or more LEDs.

The reactive component 22 of a first reactive type is preferably a shunt capacitor, adapted to selectively shunt the AC supply 5 through the shunt capacitor.

In a simple implementation, the reactive load 22 may comprise at least one capacitor and switch (e.g. BJT or MOSFET) connected in series between the AC supply 5 and a ground/reference voltage. The switch may be toggled so as to selectably connect the capacitor between the AC supply and reference voltage, and thereby alter the power factor of the AC supply.

In some other or further embodiments, the reactive load may comprise an inductor, a variable inductor or a variable capacitor.

In one embodiment, the shunt capacitor is supplementary to a mains buffering or smoothing capacitor of the luminaire, which may be used by conventional luminaires. Alternatively, a portion of the mains buffering or smoothing capacitor may be employed for power factor compensation.

The luminaire 2 comprises a luminaire controller 24 which is adapted to control the coupling of the reactive component 22 to the AC supply 5. In particular, the luminaire controller 24 may receive signals from the controller 4 and control an operation of the reactive load 22 based on the received signal.

The luminaire controller 24 and the controller 4 may communicate using a wired or wireless communication channel. Suitable wireless communication protocols that may be used include an infrared link, ZigBee, Bluetooth, a wireless local area network protocol such as in accordance with the IEEE 802.11 standards, a 2G, 3G or 4G telecommunication protocol, and so on. Suitable wired communication protocols include Ethernet technologies, e.g. in accordance with the IEEE 802.3 standards, or possibly DALI methodologies. Other formats will be readily apparent to the person skilled in the art.

In other embodiments, the reactive component 22 of the first reactive type may be adapted to receive signals directly from the controller 4, such that the controller 4 directly controls the operation of the reactive component 22 of the first reactive type.

In this way, it will be apparent that the controller 4 controls the coupling of the reactive component 22 of the first reactive type of each luminaire, for example, directly or through a luminaire controller 24.

By controlling how the reactive component 22 couples to the AC supply, a power factor of the AC supply may be adjusted. For example, the controller 4 may respond to changes in the appliance with a reactive load of the second reactive type (external to the luminaires) by coupling or decoupling the reactive component 22 of the luminaire 2 to the AC supply 5.

Thus, the lighting network 5 may improve a power factor of the AC supply caused by an appliance or other load external to the lighting network 5. In particular, a central or single controller may control the operation of each luminaire. This enables new control strategies to be implemented (e.g. coupling only a subset of luminaires) and reduces a burden of a luminaire controller, thereby increasing an efficiency of the system.

Each luminaire 2 of the lighting network 1 thereby comprises a switchable reactive component 22 (such as a capacitor), which can be connected to the AC supply 5 (in parallel to other components of the luminaire 2) by the luminaire controller 24 whenever reactive power compensation of the AC supply 5 is required.

The luminaire 2 also comprises a lighting driver 25, adapted to drive the lighting arrangement 21 using at least the AC supply. In some example, the lighting driver 25 comprises an AC to DC converter. Thus, the AC supply 5 may power the lighting arrangement 21 of the luminaire.

The luminaire 2 may also comprise an energy storage system 26, 27. The energy storage system comprises a battery 26 and a battery control circuit 27. The battery 26 may be charged by the battery control circuit 27 (via the lighting driver 25) when a power of the AC supply 5 available to the light emitting arrangement 21 is greater than a power required to drive the light emitting arrangement 21. The battery may be discharged by the battery control circuit 27, so as to drive the light emitting arrangement 21, when a power of the AC supply available to the light emitting arrangement 21 is less than a power required to drive the light emitting arrangement. This may, for example, be due to an interruption to the AC supply or due to the coupling of the reactive load 22 to the AC supply (e.g. when compensating for an improper power factor of the AC supply 5).

The luminaire 2 may comprise an input terminal 28 adapted to receive an AC supply. This may, for example, comprise of a single node or a pair of differential nodes. The reactive load 22 may be controllably connectable to the input terminal (or between differential nodes of the input terminal). This enables the luminaire to contribute to controlling the power factor of the AC supply.

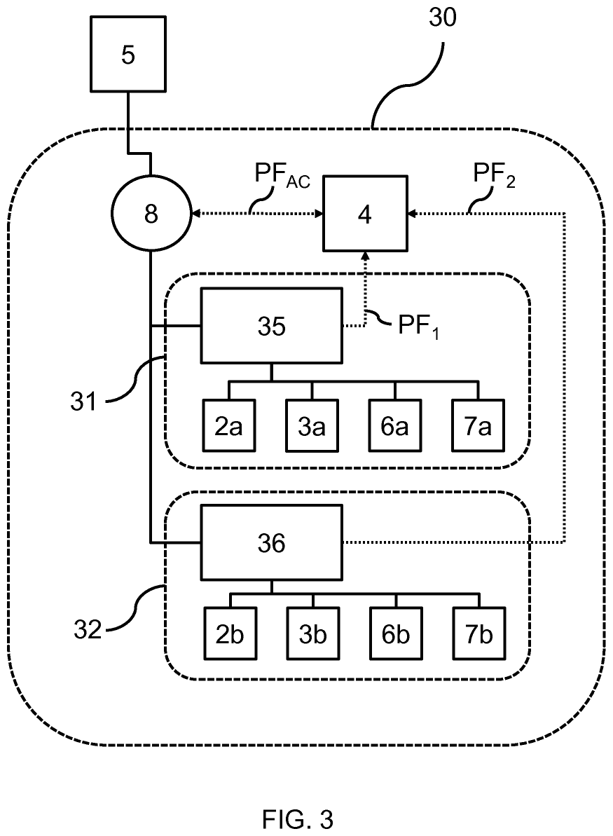

FIG. 3 illustrates a lighting network according to a second embodiment, in the context of a more complex electrical network 30. Again, the electrical network may represent an electrical network of a building or other infrastructure.

The electrical network 30 receives an AC supply 5 (e.g. mains supply). A power factor of the AC supply 5 may be monitored by a (main) meter 8, which generates a power factor signal PF_{AC}.

The AC supply 5 is distributed between a plurality of distribution branches 31, 32 or sub-networks of the electrical network 30. Each distribution branch represents a different fork or branch from the AC supply 5, and may be associated with a different group or set of loads. The electrical network 30 comprises a first distribution branch 31 and a second distribution branch 32. Each distribution branch may be considered to have its own individual AC supply.

A distribution branch 31, 32 contains components/loads which connect to the AC supply via a same node of the electrical network.

In preferable embodiments, the meter 8 acts as or is integrated in a distribution panel of the electrical network 30. The distribution panel is adapted to distribute the AC supply between the plurality of distribution branches. In other embodiments, there may be a separate, dedicated distribution panel. Optionally, the distribution panel 8 may isolate each distribution branch from one another.

Each distribution branch 31, 32 may be associated with a respective power factor detector or sub-meter 35, 36. The sub-meter may be adapted to measure a power factor signal PF₁, PF₂ of the AC supply in that branch. Thus, a sub-meter 35, 36 may act as a dedicated power factor detector for a particular distribution branch.

The first distribution branch 31 comprises a first sub-meter 35 and the second distribution branch 32 comprises a second sub-meter 36. The first sub-meter detects a power factor of the AC supply in the first distribution branch 31 so as to generate a first power factor signal PF₁, and the second sub-meter detects a power factor of the AC supply in the second distribution branch 32 so as to generate a second power factor signal PF₂.

The meter 8 and each sub-meter 31, 32 may each pass a separate power factor signal PF_{AC}, PF₁, PF₂ to the controller 4 using any wired or wireless communication channel. Thus, the controller 4 may obtain one or more power factor signals PF_{AC}, PF₁, PF₂ respectively representative of an AC supply of the electrical network, an AC supply at a first distribution branch, an AC supply at the second distribution branch and so on. It will be apparent that each power factor signal obtained in this manner will be representative of a power factor of the AC supply in either a respective distribution branch or the overall network 30.

Each sub-meter may also act as or be integrated in a distribution panel for loads of that distribution branch (i.e. a sub-distribution panel), and may optionally isolate loads of the distribution branch from one another.

The first distribution branch 31 comprises a plurality of luminaires 2a, 3a, and one or more appliances 6a, 7a. As previously described, each luminaire comprises a light emitting arrangement and a reactive component of a first reactive type. The reactive load of each appliance may be different from one another. The combined reactive load of all appliances may form the reactive load of the second reactive type.

The second distribution branch 32 similarly comprises a plurality of luminaires 2b, 3b and one or more appliances 6b, 7b. Thus, each distribution branch contains a mix of luminaires 2a, 3a, and appliances 6a, 7a.

The lighting network thus comprises two or more sets 31, 32 of luminaires.

The controller 4 controls the coupling of the reactive components of the luminaires 2a, 3a, 2b, 3b to the AC supply to thereby control the power factor of the AC supply. This in particular allows for control of an AC supply in a particular distribution branch. The controller 4 may perform this controlling in a number of different modes.

In an operational mode in which each sub-network independently performs its own power factor adjustment, the controller 4 controls the reactive components of the luminaires 2a, 3a of the first distribution branch based on at least a first power factor signal PF₁ received from the first sub-meter 35. Similarly, the controller 4 may control the reactive components of the luminaires 2b, 3b of the second distribution branch 32 based on at least a second power factor signal PF₂ received from the second sub-meter 36.

To perform a correction or other alteration of the power factor of the AC supply, the controller 4 controls a coupling of a plurality of reactive components of a first reactive type (positioned in a plurality of luminaries) to the AC supply.

A magnitude of this controlled alteration of the power factor may be varied by coupling different numbers of reactive components of the first reactive type to the AC supply; causing different numbers of the luminaires to participate in power factor compensation; adjusting a pattern of luminaires participating in power factor compensation and so on. Where luminaires comprise reactive components of the first reactive type having a variable impedance (e.g. variable capacitors or variable inductors), the controller 4 may control an impedance of individual reactive components of the first reactive type so as to increase a precision of power factor adjustment.

Thus, the controller 4 reads a power factor from sub-meters 35, 36, each associated with a respective set 31, 32, of luminaires and/or other appliance with a reactive load, to thereby identify sub-networks or distribution branches having an AC supply with an affected power factor. The controller 4 will control the luminaires of the affected sub-network or branch to participate in power factor compensation. Thus, the controller 4 may cause reactive components of a first reactive type of luminaires 2a, 3a in a particular distribution branch 31 to correct or compensate for a power factor deviance caused by the appliances 6a, 7a with a reactive load of a second reactive type in that same distribution branch. Thus, each set 31, 32, of luminaires is controlled based on a power factor of an AC supply provided to that set of luminaires.

Controlling the reactive components of the luminaires 2a, 3a based on a power factor signal PF₁ associated with the distribution branch 31 of that luminaire 2a, 3a, ensures that power factor compensation is performed in a same sub-network 31 as the loads 6a, 7a affecting the power factor. This improves a quality and efficiency of power factor correction.

In this way, the controller 4 controls the coupling of the first reactive components of the luminaires in the first distribution branch based on the power factor of the AC supply in the first distribution branch. The luminaires of the first distribution branch may thereby compensate for the change in power factor caused by the appliance(s) with a reactive load of the second reactive type in the first distribution branch.

The lighting network may therefore be connectable to a first distribution branch 31 of the AC supply, wherein the one or more appliances are in the same first distribution branch, and the lighting network further comprises a power factor detector adapted to detect the power factor of the AC supply in the first distribution branch, and the controller is adapted to receive the power factor signal from the power factor detector.

In an operational mode in which each sub-network contributes to power factor adjustment of the whole network, the controller 4 controls the reactive components of the luminaires 2a, 3a, 2b, 3b of the first 31 and second 32 distribution branches based on a power factor signal PF_{AC} of the entire electrical network. Thus, there may be a system-wide compensation for the power factor of the electrical network 30. This may be of particular use when a large amount of compensation is required to correct a power factor of the AC network (e.g. when luminaires of a particular distribution branch are unable to correct the AC supply in that distribution branch), as the full breadth of the luminaires correction capabilities may be exploited.

Thus, power factor correction need not only be at a group or distribution branch level. Rather, it can be at an entire electrical network level. For example, a main meter 8 may read the power factor of the electrical network 30 and the controller 4 may instruct groups of luminaires (in respective distribution branches) to participate in reactive power compensation. In this case, instead of measuring the effective power factor at group or sub-network level, it is measured at building or whole network level.

In a ‘multi-network’ operational mode, the controller 4 controls the reactive components of the luminaires 2a, 3a of the first network based on a first power factor signal PF₁, associated with the first distribution branch, and a second power factor signal PF₂, associated with the second distribution branch.

Thus, the controller may control the reactive components of one or more luminaires in a particular branch based on the power factor of an AC supply in that particular branch and other branches of the electrical network 30. Thus, each sub-network may contribute to adjusting a power factor of the AC supply based on its own sub-network and other sub-networks.

Preferably, the controller controls sets of luminaires based on a proximity between sets of luminaires. For example, if a lighting system has five sets of luminaires, and a power factor associated with the third set is deviant, the controller may control the luminaires in the second, third and fourth sets. This may reduce an effective length of current harmonics flow in a wire.

A multi-network operational mode may be particular advantageous if a deviance of a power factor of an AC supply is attributed to a second distribution branch 32, but the second distribution branch alone is unable to correct this deviance. In this way, the luminaires in the first distribution branch 31 may assist in correction of the power factor of the AC supply.

The skilled person will appreciate that the controller 4 may operate according to any number of different modes, which combines various aspects of the approaches previously described. In particular, the reactive components of the luminaires may be controlled according to a power factor signal PF_{AC} associated with the whole network and power factor signals PF₁, PF₂ associated with different sub-networks.

Thus, any combination of power factor signals (e.g. power factor signal PF_{AC} and the first power factor signal PF₁) may be used to control the operation of the reactive components of the luminaires to advantage.

In at least one embodiment, a distribution branch may be associated with a particular floor of a building. Thus, a first distribution branch may contain all the loads connected to the electrical supply on a first floor, and the second distribution branch may contain all the loads connected to an electrical supply on the second floor and so on.

Of course, there may be further distribution branches (e.g. a third distribution branch, a fourth distribution branch and so on). In this way, there may be more than two sets of luminaires. In some examples, an AC supply in a distribution branch may be further divided into sub-distribution branches. The luminaires in such sub-distribution branch may be controlled in a similar manner to the distribution branches described above, for example, based on one or more power factor signals indicative of a power factor of an AC supply of: the electrical network, the ‘patent’ distribution branch and/or of the sub-distribution branch.

Preferably, the controller selects which luminaires are involved in power factor adjustment based on a proximity of the luminaire(s) to an appliance forming a reactive load of the second reactive type.

Consider a scenario in which an electrical network has a single appliance with a reactive load of the second reactive type and a lighting network comprising 100 luminaries. In the event that only 10 luminaries are required to compensate for a power factor deviance caused by the appliance with a reactive load of the second reactive type, the controller may control the operation of the 10 luminaires most proximate to the single reactive load of the second reactive type.

In some embodiments, all luminaires and other loads (including at least the reactive load(s) of a second reactive type) have a communication port for communicating with the controller 4. The controller 4 may be capable of identifying the loads and luminaires by their communication addresses and may obtain the physical or relative location (e.g. in the distribution hierarchy of the AC supply) of all appliances and luminaires. The controller may switch the reactive loads of the luminaires most proximate to the appliance(s).

Thus, in embodiments, all luminaires have a communication address (e.g. MAC ID, IP address, or DALI address) for communication purposes. During installation of the luminaires or lighting network, these addresses may be loaded in the controller (e.g. central energy manager) in the form of table mapping. In this way, the controller may know which group a luminaire belongs to, adjacent groups to the luminaire and a physical location of a luminaire.

For selecting a luminaire, the controller may run an algorithm based on the amount of power factor correction required. If more reactive power needs to be compensated then a greater number of luminaires are selected.

Determining the proximity of luminaires to the appliances may include determining an effective length of wire between the luminaires and the appliances.

A proximity-based control method helps in reducing the high peak current path. In particular, selecting the luminaires (for adjusting the power factor) closest to appliances helps in reducing the effective length of current harmonics flow in wire(s). If the compensation is done by more distant luminaires, then a supply having poor current harmonics is transmitted up to the more distant luminaires, which may affect the power supply provided to other components of the electrical network.

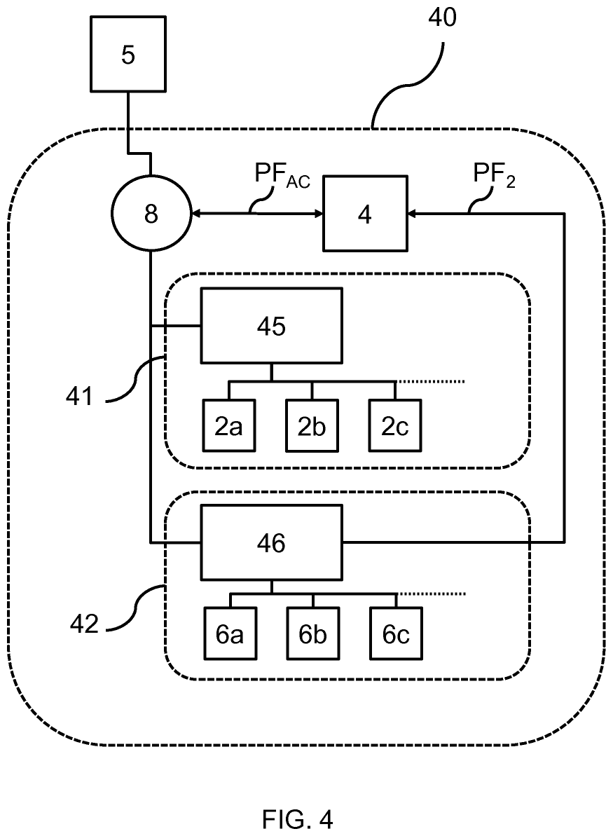

FIG. 4 illustrates a lighting network according to a third embodiment, in the context of a different electrical network 40. The electrical network 40 is similar to the electrical network 30 of FIG. 3, except that the load connected to the first distribution branch 41 consists of a plurality of luminaires 2a, 2b, 2c; and the load connected to the second distribution branch 42 consists of one or more appliances 6a, 6b, 6c.

Thus, in the electrical network 40, the lighting network is connectable to a first distribution branch of the AC supply 5, where the appliances are connected to a second, different distribution branch of the AC supply 5. Thus, luminaires and appliances are connected in different distribution branches from the AC supply 5.

The controller 4 is adapted to receive a remote power factor signal PF₂ from a remote power factor detector associated with the appliance(s) with a reactive load of the second reactive type in the second distribution branch. Here, the remote power factor detector is embodied as the second sub-meter 46 of the second distribution branch.

The controller 4 controls the coupling of the reactive components of the first reactive type (of each of the plurality of luminaires 2a, 2b, 2c) based on the remote power factor signal PF₂.

In this way, luminaires positioned in a first distribution branch are used to compensate or correct a power factor deviance caused by one or more appliances with a reactive load in a second, different distribution branch. Thus, a first distribution branch may be adapted to compensate a reduction in the power factor of the AC supply caused by a second distribution branch.

The first sub-meter 45 may, for example, provide feedback to the controller 4 about the power factor of the first distribution branch (e.g. to indicate whether the reactive components of the luminaires are being appropriately controlled). In some embodiments, the controller 4 may also control the coupling of reactive components of the luminaires based on a power factor signal (not shown) from the first sub-meter.

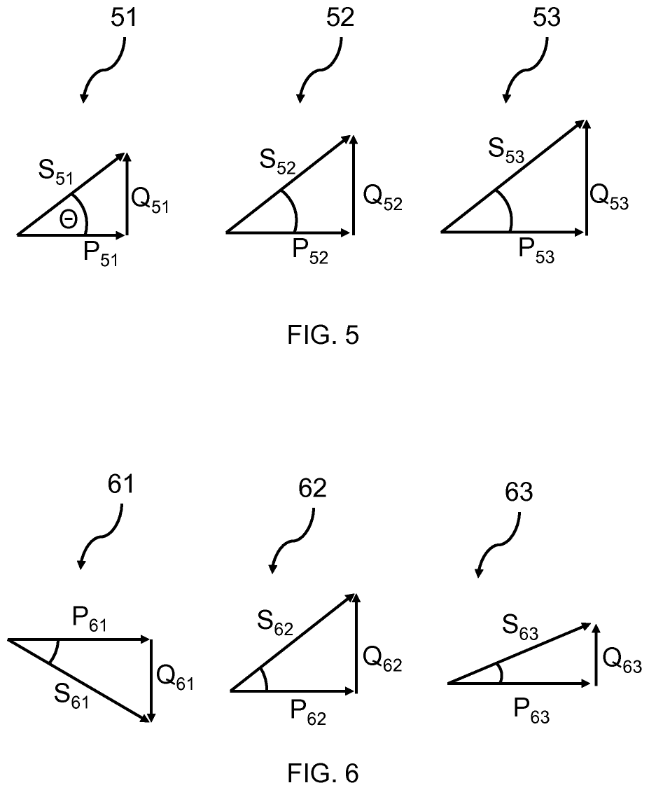

FIG. 5 illustrates a power triangle 51 for a lighting load, a power triangle 52 for other loads and a power triangle 53 for a total/combined load of the electrical network 40, before power factor correction is performed.

A power triangle illustrates the relationship between an apparent power S, a reactive power Q and a true/real power P. The reactive power is often considered unusable power for the loads, and is often measured in the unit “var” commonly referred to as the vol-ampere reactive. The relationship between apparent power S, reactive power Q, true power P and power factor PF is well known, in accordance with the following equations:

P=S·PF=S·cos θ (1)

Q=\sqrt{S²−P²} (2)

where Θ is an angle between the apparent power and the true power within the power triangle, commonly referred to as the phase angle.

A following scenario is described in which the electrical network 40 has a total load of 100 kVA.

30% is associated with a lighting load (i.e. the lighting load is 30 kVA), consisting of all luminaires in the electrical network, having a lighting load power factor of around 0.9 lag. Thus, the apparent power S₅₁ of the lighting load is 30 kVA, the reactive power Q₅₁ is 13 kvar and the true power P₅₁ is 27 kW.

The lighting load may be equivalent to the lighting network of the electrical network. This may be represented by the first distribution branch 41 of the electrical network according to the third embodiment.

The remaining 70% of the total load is associated with the other loads of the electrical network, the other loads comprising at least one appliance with a reactive load of the second reactive type. The other loads have an apparent power S₅₂ of 70 kVA and another load power factor (PF₅₂) of 0.8 lag. The other appliances may be represented by the second distribution branch 42 of the electrical network. In such a scenario, the true or real power P₅₂ associated with these other appliances is calculated based on equation (1) as follows:

P₅₂=70*0.8

P₅₂=56 kW (3)

The reactive power Q₅₂ of the other appliances (comprising the appliance with a reactive load of the second reactive type) is subsequently calculated based on equation (2) as follows:

Q₅₂=\sqrt{70²−56²}

Q₅₂=42 kvar (4)

The total apparent power S₅₃ is 100 kVA, the total reactive power Q₅₃ is 55 kvar and the total true power P₅₃ is 83 kW. This essentially sums the respective powers of the lighting load S₅₁, Q₅₁, P₅₁ and the other loads S₅₂, Q₅₂, P₅₂. The power factor or lag of the total network is 0.83 (e.g. calculated according to equation (1)).

In the above described scenario, there is scope for minimizing the reactive power of the other appliances by up to 42 kvar, in order to improve the power factor or lag of the AC supply of the electrical network. This may be performed by controlling the coupling of the reactive components/loads of the first reactive type (of the plurality of luminaires) appropriately based on a power factor signal indicative of the power factor of the AC supply to the other loads.

For example, in this scenario, the reactive power is a lag caused by appliances with an inductive load (i.e. the reactive loads of the second reactive type are inductors). The reactive components of the first reactive type (contained by respective luminaires) may thereby be capacitors, in order to compensate for the lag induced by the inductors.

The desired total reactive power compensation Q_{DES} (of the AC supply) by the plurality of luminaires is therefore 42 kvar (i.e. the reactive power of the other loads). The total reactive power compensation Q_{TOT} provided by the lighting load plurality of luminaires is dependent upon a number (N) of luminaires and an individual reactive power compensation (Q_{LUM}) of a single luminaire, which, assuming the luminaires are substantially the same, is as follows:

Q_{TOT}=N·Q_{LUM} (5)

The individual reactive power compensation of a single luminaire, which comprises a capacitor having a capacitance C_{LUM} as the reactive load of the first reactive type, may be calculated as follows:

Q_{LUM}=V²·2·π·f·C_{LUM} (6)

Where V is the voltage of the AC supply provided to the luminaire, and f is the frequency of the AC supply provided to the luminaire. If the reactive loads of the first reactive type are instead inductors, equation (6) may be appropriately replaced according to well-known principles.

Assuming the AC supply is a typical 230V, 50 Hz mains supply, equation (6) may be simplified as follows:

Q_{LUM}=5,290,000·π·C_{LUM} (7)

Taking an arbitrary capacitor value of 2.7 μF, the individual reactive power compensation Q_{LUM} of a single luminaire is therefore calculable as 45 var. Setting the total reactive power compensation Q_{TOT} to the desired total reactive power Q_{DES}, and applying equation (5) we can calculate the total number of luminaires required to compensate for the other loads as follows.

$$N = \frac{{Q}_{DES}}{{Q}_{LUM}} = \frac{42000}{45} \approx 933 \qquad ( 8 )$$

Thus, for a typical mains AC supply, the reactive components of a first reactive type (being a capacitor having a value 2.7 μF) of around 933 luminaires needs to be connected to wholly compensate for a power factor or lag of 0.8 of the appliances having reactive loads of the second reactive type. Thus, a controller may controllably couple the reactive loads of 933 luminaires to the AC power supply in order to wholly compensate for the power factor or lag caused by the other loads (including the reactive loads of the second reactive type).

The controller may thereby perform power factor correction by controllably coupling an appropriate number of reactive components of the first reactive type to the AC supply. Thus, the controller controls the number of luminaires involved in power factor correction.

FIG. 6 illustrates a power triangle 61 for the lighting load, a power triangle 62 for other loads/appliances and a power triangle 63 for a total/combined load of an electrical network, after power factor correction has been performed as described above.

The true power P₆₁ of the lighting load remains the same at 27 kW. The reactive power, due to the coupling of the reactive components of the first reactive type to the AC supply, has altered to −29 kvar (i.e. a negative value). The difference between the reactive power of the lighting load before power factor correction and after power factor correction is 42 kvar (i.e. the reactive power of the other loads of the electrical network prior to power factor correction). The apparent power S₆₁ of the lighting load is 39 kVA.

The true power P₆₂, reactive power Q₆₂ and apparent power S₆₂ of the other loads remains the same before and after power factor correction.

Whilst the true power P₆₃ of the total load after power factor correction has remained at 83 kW, the reactive power Q₆₃ of the total load has decreased from 55 kvar to 13 kVar, due to the power correction of the lighting load. Thus, the coupling of the reactive loads of the first reactive type to the AC supply has wholly compensated for the power factor variance caused by the appliances with a load of the second reactive type.

The apparent power S₆₃ has also decreased to 84 kVA.

Thus, a power efficiency of the electrical system has been significantly improved. A grid stability and power quality of the AC supply has also been improved.

The above scenario has been described purely for the sake of improved understanding. The skilled person will appreciate that the reactive components of the first reactive type may instead or further comprise inductors or capacitors of other values, which will enable appropriate control or adjustment of the power factor of the AC supply.

A lagging power factor (positive reactive power) indicates that a current lags a voltage, and a leading power factor (negative reactive power) indicates that a current leads a voltage (or a voltage lags the current). Inductive loads cause the power factor to lag, and capacitive loads cause the power factor to lead.

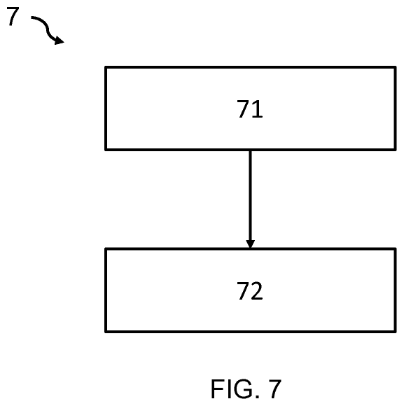

With reference now to FIG. 7, there is also proposed a method 7 of controlling a lighting network, having two or more luminaries adapted to connect to an alternating current, AC, supply, wherein each luminaire comprises a light emitting arrangement and a reactive component of a first reactive type selectively couplable to the AC supply, the method comprising: receiving 71 a power factor signal, indicative of a power factor of the AC supply, and responsive to at least one appliance with a reactive load of a second reactive type connected to the AC supply, wherein the appliance is different from the luminaire; and controlling 72 the coupling of the reactive component of each luminaire to the AC supply based on the received power factor signal so as to adjust the power factor of the AC supply.

As discussed above, embodiments make use of a controller. The controller can be implemented in numerous ways, with software and/or hardware, to perform the various functions required. A processor is one example of a controller which employs one or more microprocessors that may be programmed using software (e.g., microcode) to perform the required functions. A controller may however be implemented with or without employing a processor, and also may be implemented as a combination of dedicated hardware to perform some functions and a processor (e.g., one or more programmed microprocessors and associated circuitry) to perform other functions.

Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media such as volatile and non-volatile computer memory such as RAM, PROM, EPROM, and EEPROM. The storage media may be encoded with one or more programs that, when executed on one or more processors and/or controllers, perform the required functions. Various storage media may be fixed within a processor or controller or may be transportable, such that the one or more programs stored thereon can be loaded into a processor or controller.

As used herein, the terms ‘reactive component of a first reactive type’ and ‘reactive load of a second reactive type’ simply indicates that such components/loads have different phase angles or affect a power factor in different ways. By way of example, both reactive loads of the first and second reactive type may comprise a capacitive load, or both reactive loads of the first and second reactive type may comprise an inductive load.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A lighting network comprising:
a plurality of luminaires adapted to connect to an alternating current, AC, supply, wherein each luminaire comprises a light emitting arrangement and a reactive component of a first reactive type selectively couplable to the AC supply; and
a controller adapted to:
receive a power factor signal, indicative of a power factor of the AC supply, said power factor signal influenced by an appliance with a reactive load of a second reactive type connected to the AC supply; and
control the coupling of the reactive component of each luminaire to the AC supply based on the received power factor signal influenced by the appliance, so as to adjust the power factor of the AC supply.

2. The lighting network of claim 1, wherein the first reactive type is capacitive, and the second reactive type is inductive, and
each luminaire further comprises a lighting driver separate from the reactive component.

3. The lighting network of claim 1, the lighting network is adapted to:
be connectable to a first distribution branch of the AC supply, wherein the appliance with a reactive load of a second reactive type is in the same first distribution branch, and the lighting network further comprises a power factor detector adapted to detect the power factor of the AC supply in the first distribution branch, and the controller is adapted to receive the power factor signal from the power factor detector; or
be connectable to a first distribution branch of the AC supply, wherein the appliance with a reactive load of the second reactive type is in a second, different distribution branch of the AC supply, wherein the controller is adapted to receive the power factor signal from a remote power factor detector associated with the appliance with a reactive load of the second reactive type in the second distribution branch.

4. The lighting network of claim 1, wherein:
the plurality of luminaires comprises at least two sets of two or more luminaires; and
the controller is adapted to:
obtain a respective power factor signal associated with an AC supply provided to each set of two or more luminaires; and
control the coupling of the reactive component of each luminaire, in the plurality of luminaires, based on the power factor signal associated with the set of that luminaire.

5. The lighting network of claim 4, wherein each luminaire in a set of two or more luminaires is connected to a same node, and wherein each set of two or more luminaires is connected to a different node.

6. The lighting network of claim 4, wherein at least one set of two or more luminaires is associated with a respective set of one or more appliances with a reactive load of a second reactive type, and the controller is adapted to control the coupling of the reactive components of the at least one set of two or more luminaires.

7. The lighting network of claim 1, wherein the controller is adapted to control the coupling of the reactive component of each luminaire further based on a proximity relationship, between the respective luminaire and an appliance with a reactive load of the second reactive type, in a distribution hierarchy of the AC supply.

8. An electrical network comprising:
the lighting network of claim 1; and
at least one the appliance.

9. The electrical network of claim 8, wherein each at least one appliance comprises an inductive appliance, and optionally wherein each inductive appliance comprises: a Heating, Ventilation and Air Conditioning, HVAC, unit; an elevator; a fan; a printer; a scanner; or a fax machine; and the reactive load of the second reactive type comprises inductive coils or a motor.

10. The electrical network of claim 8, wherein the lighting network is adapted to either:
be connected to a first distribution branch of the AC supply, wherein the at least one appliance with a reactive load of a second reactive type is connected to the same first distribution branch, wherein the lighting network further comprises a power factor detector adapted to detect the power factor of the AC supply at an input node of the lighting network, and the controller is adapted to receive the power factor signal from the power factor detector; or
be connected to a first distribution branch of the AC supply, wherein the at least one appliance with a reactive load of the second reactive type is in a second, different distribution branch of the AC supply, wherein the electrical network further comprises a remote power factor detector adapted to detect the power factor of the AC supply in the second distribution branch and the controller is adapted to receive the power factor signal from the remote power factor detector.

11. The electrical network of claim 8, wherein the controller is adapted to select a subset of the plurality of luminaires based on a proximity relationship, between the subset and the at least one appliance with a reactive load of the second reactive type, in the AC distribution hierarchy.

12. A method of controlling a lighting network, having two or more luminaries adapted to connect to an alternating current, AC, supply, wherein each luminaire comprises a light emitting arrangement and a reactive component of a first reactive type selectively couplable to the AC supply, the method comprising:
receiving a power factor signal, indicative of a power factor of the AC supply, and influenced by an appliance with a reactive load of a second reactive type connected to the AC supply; and
controlling the coupling of the reactive component of each luminaire to the AC supply based on the received power factor signal so as to adjust the power factor of the AC supply.

13. The method of claim 12, further comprising detecting the power factor of the AC supply at a node of the lighting network, wherein the first reactive type is capacitive, and the second reactive type is inductive, and
wherein each luminaire further comprises a lighting driver separate from the reactive component.

14. The method of claim 12, wherein the plurality of luminaires comprises at least two sets of two or more luminaires, and the method comprises:
obtaining a respective power factor signal associated with an AC supply provided to each set of two or more luminaires;
controlling the coupling of the reactive component of each luminaire, in the plurality of luminaires, based on the power factor signal associated with the set of that luminaire.

15. A computer program product comprising computer program code means adapted to implement the method of claim 12 when said program is run on a computer.
